(19) United States
(12) Patent Application Publication
(10) Pub. No.: US 2002/0079372 A1
(43) Pub. Date: Jun. 27, 2002

(54) Packing box, method for manufacturing the packing box, method for using the packing box, and method for reading information thereon

(76) Inventor: Mariko Hino, Kanagawa (JP)

Correspondence Address: DERGOSITS & NOAH LLP, Suite 1150, Four Embarcadero Center, San Francisco, CA, 94111, US

(21) Appl. No.: 09/898,137

(22) Filed: Jul. 3, 2001

(30) Foreign Application Priority Data
Jul. 6, 2000 (JP) 2000-205716
Jun. 8, 2001 (JP) 2001-174011

(51) Int. Cl. G06K 7/10

(52) U.S. Cl. 235/462.01

(57) ABSTRACT

A packing box, a method for manufacturing the packing box, and a method for using the packing box permit easier reading of an identification code attached to an article. The packing box is provided with a window-forming portion formed such that it is aligned with an identification code attached to an electronic device accommodated in the packing box. The window-forming portion remains unopened until an external force is applied thereto. The window-forming portion opens when subjected to a predetermined level of pressure.

### FIELD OF THE INVENTION

The present invention relates to a packing box provided with a window-forming portion that does not function as a window until the moment comes to read an identification code, such as a bar code, attached to an article, a method for manufacturing the packing box, a method for using the packing box, and an information reading method for reading information from an identification code attached to an article accommodated in the packing box.

### BACKGROUND OF THE INVENTION

Nowadays, bar codes or other types of article identification codes are individually printed on or attached to numerous articles to indicate the histories or the like of the articles. Each article identification code is composed of specific information, including the serial number of the article to which the identification code is attached, namely, the date of manufacture, the model number, the ID code, the price, and other information necessary for distribution.

The specific information included in, for example, a bar code attached to an article is read by a bar code reader at, for example, a cashier of a super market. The names, prices, etc. are sorted out and totaled so as to use the obtained data for the analyses of articles for sales, the management of stockage, inventory control, etc.

Such bar codes are also attached to electronic devices, such as entertainment devices typically represented by video game devices, and these bar codes are read at outlet stores at the point of sales. This allows outlet stores, manufacturers, etc. to secure information regarding the outlet stores at which the individual devices have been sold to users.

The bar codes attached to articles can be directly read by a bar code reader if the bar codes are attached to the packaging materials that package the articles as in the case of the articles sold at, for example, supermarkets.

However, the electronic devices, such as entertainment devices, are always accommodated in packing boxes since they are precision electronic devices, and the bar codes are attached to the electronic devices rather than the packing boxes thereof. Hence, the bar codes attached to the electronic devices themselves cannot be directly seen from outside the packing box thereof.

To be more specific, electronic devices are accommodated in packing boxes together with protective packing materials, such as Styrofoam (registered trademark), primarily to protect the electronic devices from external shocks and to maintain and stabilize their position during transport. The electronic devices remain accommodated in the packing boxes during transport or storage at outlet stores, and the bar codes attached to the electronic devices are invisible from outside.

Therefore, to read the bar codes of electronic devices at outlet stores, for example, the packing boxes must be opened and the electronic devices must be taken out together with protective packing materials, or protective packing materials must be partly removed to take out electronic devices before reading the identification codes on the electronic devices. Thus, reading the bar codes of the electronic devices requires an extremely cumbersome operation that includes the steps of: (1) opening a packing box; (2) taking out an electronic device together with a protective material from the packing box, then removing the protective material, or taking out a part of the protective material from the packing box, then taking out the electronic device; (3) reading the identification code of the electronic device; and (4) re-packing the electronic device.

### SUMMARY OF THE INVENTION

Accordingly, it is an object of the present invention to provide a packing box that obviates a cumbersome operation of unpacking and re-packing an electronic device thereby to permit easier reading of the identification code attached to the electronic device, a method for manufacturing the packing box, a method for using the packing box, and a method for reading information.

It is another object of the present invention to provide a method for manufacturing a packing box, a method for using the packing box, and a method for reading information that prevent wasteful consumption of resources and permit easy reading of identification codes attached to electronic devices.

To these ends, according to one aspect of the present invention, there is provided a packing box for accommodating an article therein, comprising a window-forming portion that is formed in at least one face of the box and functions as a window when a predetermined level of pressure is applied thereto.

With this arrangement, the window-forming portion functions as a window when a predetermined level of pressure is applied thereto. Hence, by positioning a bar code or other type of identification code attached to an article at the position where the window section is located, the information contained in the identification code can be easily read. The identification code may be a bar code.

The phrase “when pressure is applied” also implies “when a level of pressure lower than the predetermined level of pressure is applied”, which will be discussed hereinafter. More specifically, for example, when a predetermined level of pressure, which will be discussed hereinafter, is applied to cause the window-forming portion to act as a window, then removed, the window may close due to elastic restoration or the like of the window-forming portion. A lower level of pressure than the predetermined level of pressure will be required to cause the window-forming portion to act as a window in such a state. The foregoing phrase “when pressure is applied” will also include the above case.

Alternatively, the window-forming portion may be formed such that it remains closed so as to function as part of a face of the box until a predetermined level of pressure is applied thereto.

If a window is formed, for example, in one of the faces of a box, then the strength of the face having the window is deteriorated. Therefore, the strength of the face is compensated by, for example, increasing the thickness of a protective member that is accommodated together with an article in the box. This, however, presents a problem in that resources are wastefully consumed or reading accuracy is deteriorated. According to the present invention, however, the window-forming portion remains unopened until a predetermined level of pressure is applied, thus adequately securing the strength of the face wherein the window-forming portion has been formed. This will obviate the need for increasing the thickness of a protective member, making it possible to solve the problem of the wasteful consumption of resources and the deteriorated reading accuracy.

Preferably, the window-forming portion is formed in the face at a position that coincides with the position of the identification code attached to an article when the article is placed in the box. This allows the identification code on the article, which has been accommodated in a packing box, to be easily read through the window when the window-forming portion functions as the window.

When the article is placed in the box together with a protective member, a gap may be provided at least between the window-forming portion and the article. With this arrangement, when the window-forming portion functions as a window, there will be the gap rather than the protective member, between the window and the article, so that the identification code on the article in the packing box can be easily read through the window.

Furthermore, window-forming portion may be composed of a portion that can be partially cut with ease and a portion that can be partially bent with ease. More specifically, the portion that can be partially cut with ease is cut, then the portion that can be partially bent with ease is bent to make the window-forming portion act as a window. The portion that can be partially cut with ease may be formed by a combination of a portion to be partially cut and a connecting portion.

According to another aspect of the present invention, there is provided a method for manufacturing a packing box for accommodating an article therein, whereby a window-forming portion functioning as a window when a predetermined level of pressure is applied thereto is formed in at least one of a plurality of developed faces making up the packing box.

In this case, preferably, the plurality of developed faces are formed by blanking a paper material, and the window-forming portion is formed in at least one of the developed faces at the same time. This permits a simplified manufacturing process to be achieved.

The window-forming portion may be produced by forming a portion that can be partially cut with ease and a portion that can be partially bent with ease in at least one of the developed faces.

According to yet another aspect of the present invention, there is provided a method for using a packing box for accommodating an article, such as an electronic device, therein, including the steps of forming a window-forming portion that functions as a window when subjected to a predetermined level of pressure and is provided in at least one face of the packing box, attaching an identification code to the article, placing the article in the packing box such that the position of the identification code attached to the article coincides with the position of the window-forming portion, applying the predetermined level of pressure to the window-forming portion to cause the window-forming portion to function as a window for reading the identification code attached to the article, and reading the identification code on the article.

In this case, the window-forming portion may be designed so that it remains unopened until the predetermined level of pressure is applied, then it opens when subjected to the predetermined level of pressure so as to function as a window. The window-forming portion may be made by forming a portion that can be partially cut with ease and a portion that can be partially bent with ease in at least one of the plurality of faces. The identification code attached to the article may be a bar code.

According to still another aspect of the present invention, there is provided a method for reading information from an identification code attached to an article accommodated in a packing box, whereby the information of the identification code of the article is read through a window-forming portion that is formed in at least one face of the packing box and functions as a window when a predetermined level of pressure is applied thereto.

In this case, preferably, the window-forming portion is formed such that it is aligned with the position of the identification code attached to the article. Furthermore, to read the identification code of the article, the predetermined level of pressure may be applied to the window-forming portion to cause the window-forming portion to function as a window so as to read the information from the identification code of the article.

### BRIEF DESCRIPTION OF THE DRAWINGS

FIG. 1A is a perspective view showing a packing box according to a prior art example,

FIG. 1B is a perspective view showing a state wherein the cover of the packing box according to the prior art example is open,

FIG. 1C is a perspective view showing a protective member accommodated in the packing box according to the prior art example,

FIG. 1D is a perspective view showing an electronic device accommodated in the packing box according to the prior art example, and

FIG. 1E is a sectional view of a portion of the protective member around the window;

FIG. 2A is a perspective view showing an example of the packing box according to an embodiment of the present invention, and

FIG. 2B is a perspective view showing a state wherein a predetermined level of pressure has been applied to a window-forming portion to cause the window-forming portion to function as a window;

FIG. 3A is a development elevation showing the packing box shown in FIG. 2, and

FIG. 3B is an enlarged view showing the window-forming portion;

FIG. 4A is a perspective view showing the packing box according to the embodiment,

FIG. 4B is a perspective view showing the protective member, and

FIG. 4C is a perspective view showing an electronic device;

FIG. 5A is a schematic representation showing an enlarged view of the window-forming portion,

FIG. 5B is a schematic representation showing a state wherein a bar code attached to the electronic device is being read by using a bar code reader, and

FIG. 5C is a schematic representation showing a state wherein a part of the window-forming portion has been bent outward; and

FIGS. 6A through 6E are schematic representations showing modification examples of the window.

### DESCRIPTION OF THE PREFERRED EMBODIMENTS

For easy understanding of an embodiment of the present invention, an example of an already proposed packing box and how to use the packing box (hereinafter is referred to as “the prior art example”) will be briefly described first.

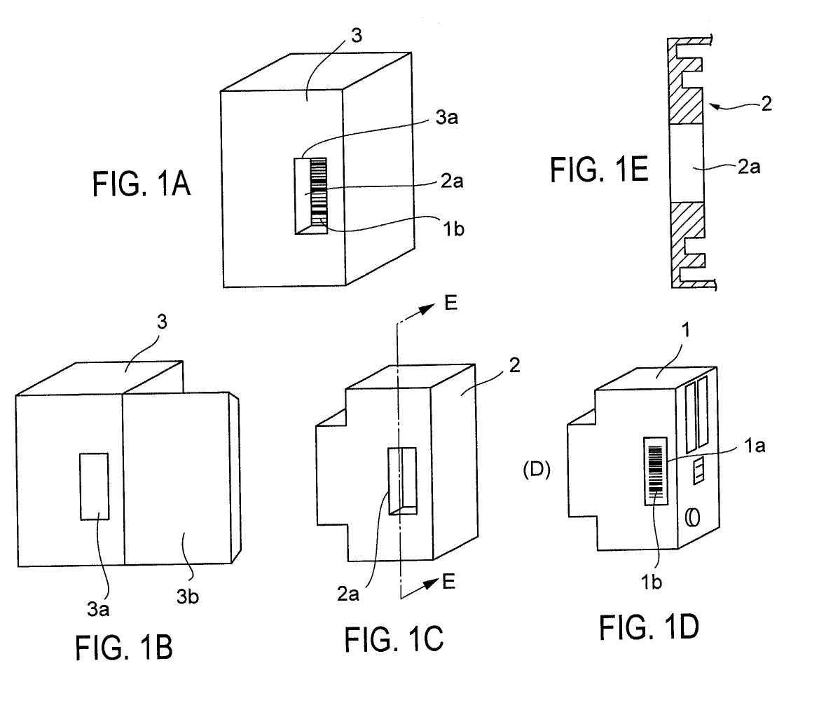

Referring to FIG. 1A through FIG. 1E, a packing box 3 according to the prior art example will be explained. In the packing box 3 according to the prior art example, a window or opening 3a has been formed beforehand such that it coincides with the position of a bar code 1b attached to an electronic device 1, which is an article accommodated in the packing box 3. The following will provide specific descriptions.

FIG. 1A shows a state wherein an article, e.g., the electronic device 1, has been placed in the packing box 3. The electronic device 1 is accommodated in the packing box 3 together with a protective member 2 (see FIG. 1C) formed of a buffer material, such as Styrofoam. The protective member 2 has a window 2a formed to coincide with the position of the bar code 1b attached to the electronic device 1. Furthermore, the packing box 3 also has a window 3a aligned to the window 2a.

Thus, when the electronic device 1 is placed in the packing box 1 together with the protective member, the bar code 1b attached to the electronic device 1 can be directly recognized visually from outside the packing box 3, and can be read by a bar code reader (not shown in FIG. 1).

FIGS. 1B, 1C, and 1D illustrate the packing box 3 shown in FIG. 1A, the protective member 2, and the electronic device 1, respectively.

More specifically, FIG. 1B shows the packing box 3 in which the window 3a has been formed, a cover 3b being opened. FIG. 1C shows the protective member 2 accommodated in the packing box 3, for example, with substantially no gap therebetween. The protective member 2 has a hollow portion shaped to the contour of the electronic device 1. In the protective member 2, the window 2a is formed to be aligned with the window 3a of the packing box 3. FIG. 1D shows the electronic device 1 and a label 1a carrying the bar code 1b attached to at least one face of the electronic device 1.

Thus, when the electronic device 1 is retained in the hollow portion of the protective member 2 and accommodated in the packing box, the bar code 1b attached to the electronic device 1 will be aligned with the window 2a of the protective member 2 and the window 3a of the packing box 3.

In the packing box 3 according to the prior art example, the mechanical strength of the portion around the window 3a may be deteriorated because the window or opening 3a formed to expose the bar code 1b on the electronic device 1 must be formed. For this reason, in the prior art example, the portion around the window 2a of the protective member 2 is made thicker than that of the remaining portion, as shown in FIG. 1E, thereby to reinforce the portion around the window 3a of the packing box 3.

Specifically, when the window 3a is formed in the packing box 3, the mechanical strength of the portion surrounding the window 3a deteriorates; therefore, the thickness of the portion surrounding the window 2a in the protective member 2 is increased to make up for the deterioration of the mechanical strength.

The size and thickness of the window 2a of the protective member 2 and the size of the window 3a of the packing box 3 are decided on the basis of the dimension of the bar code reader to be used, the dimension of the bar code 1b, etc.

In the process of shipping the electronic device from a manufacturer, the electronic device is accommodated in the packing box together with the protective member. From this stage of shipment, the bar code 1b attached to the electronic device 1 is exposed outside through the window 2a of the protective member 2 and the window 3a of the packing box 3.

The inventor has found out that the prior art example described above poses the following problems:

(1) Wasteful Consumption of Resources

In the prior art example, since the window 3a is formed in the packing box 3, the mechanical strength of the portion around the window deteriorates. Therefore, the portion around the window 2a of the protective member 2 accommodated together with the electronic device 1 in the packing box 3 is made thicker so as to indirectly reinforce the mechanical strength of the packing box 3.

The protective member 2 serves as the protective member for the electronic device 3 during transport, storage, reading by a bar code reader, etc., and is discarded when a user unpacks and starts using the electronic device 3. In the prior art example, since the window 2a is formed in the protective member 2, it seemingly reduces a consumed material accordingly. On the other hand, however, the thickness of the portion surrounding the window is considerably increased in order to enhance the mechanical strength of the packing box. As a result, the quantity of materials consumed is increased as a whole.

(2) Deteriorated Accuracy of Reading

The thickness of the portion surrounding the window 2a of the protective member 2 is increased, leading to an increased distance from the window 3a of the packing box 3 to the bar code 1b attached to the electronic device 1 in the packing box 3.

Hence, to read the bar code 1b on the electronic device 1 by a bar code reader, the bar code reader must be inserted through the window 3a of the packing box 3 to access the bar code 1b on the electronic device 1.

If, however, the bar code reader is larger than the window 2a or 3a, then the bar code 1b has to be read from outside the packing box 3, leading to the possibility of deteriorated accuracy of reading.

(3) Problem with Environmental Resistance During Transport and Storage

In the packing box according to the prior art example, the window 3a is formed in advance. In other words, the window 3a is open at the time of shipment. This means that there is a possibility of humidity, dust, etc. entering through the window 3a and the window 2a formed in the protective member 2 during the subsequent transport, storage, etc. Thus, the packing box according to the prior art example poses a problem in the aspect of environmental resistance.

(4) Other Problems Caused by the Window Opened from the Beginning

If a manufacturer includes information that should be maintained confidential in the bar code 1b attached to the electronic device 1 accommodated in the packing box 3, then the information included in the bar code 1b can be easily read since the window 3a formed in the packing box 3 is initially open. The fact that a third party could easily have access to the bar code during transport or storage may be problematic in the aspect of confidential nature or the like when there are a large number of commodities in one place.

The inventor has pointed out the problems described above and proposed novel inventions primarily of a new packing box that solves the aforesaid problems, a method for manufacturing the same, and a method for using the same.

In conjunction with the accompanying drawings, an embodiment of the packing box, a method for manufacturing the same, and a method for using the same in accordance with the present invention will be described in detail by comparing the packing box according to the present invention with the packing box according to the prior art example.

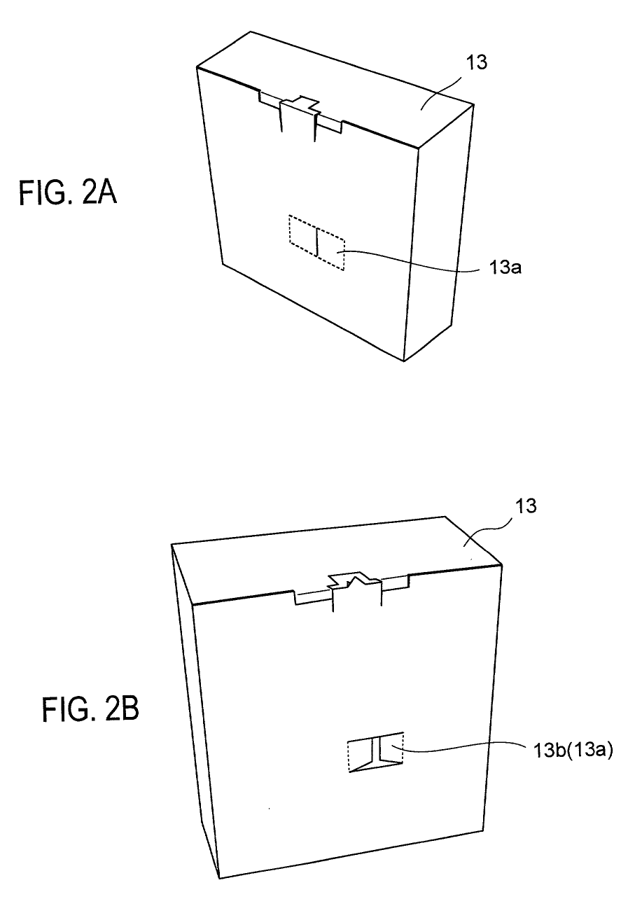

FIG. 2 through FIG. 6 show the embodiment in accordance with the present invention. FIG. 2 shows an example of a packing box 13 according to the embodiment. At least one face of the packing box 13 is provided with a window-forming portion 13a. The window-forming portion 13a is not opened and forms a part of the face, until a predetermined level of pressure is applied thereto. The window-forming portion 13a is opened to become a window 13b when the predetermined level of pressure is applied thereto (e.g., when it is pushed by a finger). In other words, the window-forming portion 13a functions as the window 13b when it is subjected to the predetermined level of pressure.

FIG. 2A shows the window-forming portion 13a that has been formed in one face. FIG. 2B shows the window-forming portion 13a that has been subjected to the predetermined level of pressure and opened to become the window 13b. The window-forming portion 13a is formed by perforating or bending a material during its manufacture process, and remains unopened at this stage. Even when a three-dimensional box is formed, the window-forming portion 13a remains flush with the face of the packing box 13 and unopened unless the predetermined level of pressure is applied thereto by pushing it by figure or the like.

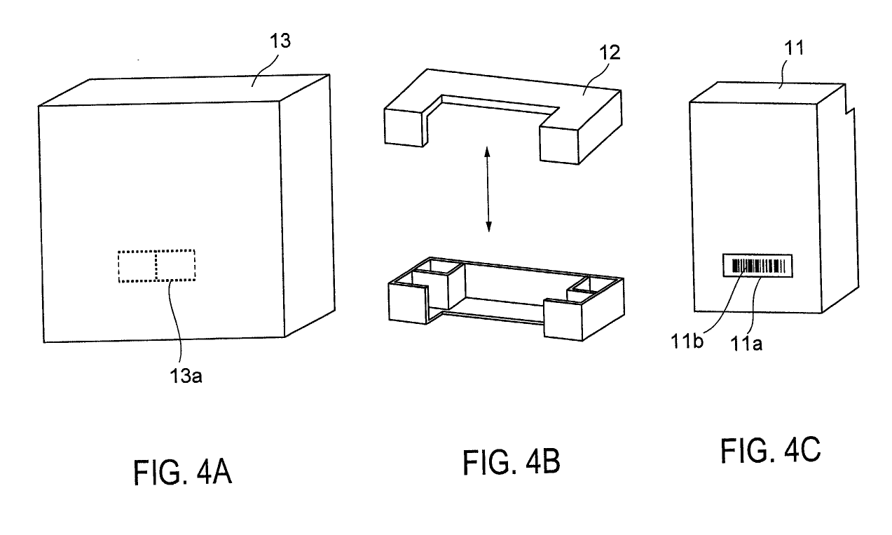

When reading a bar code 11b attached to an electronic device 11 (see FIG. 4C), the predetermined level of pressure is applied to the window-forming portion 13a of the packing box 13 by pushing it with a finger or the like so as to partially break the window-forming portion 13a along perforated lines and bend it at bending lines. Through this process, the window-forming portion 13a is opened to form the window 13b, as shown in FIG. 2B.

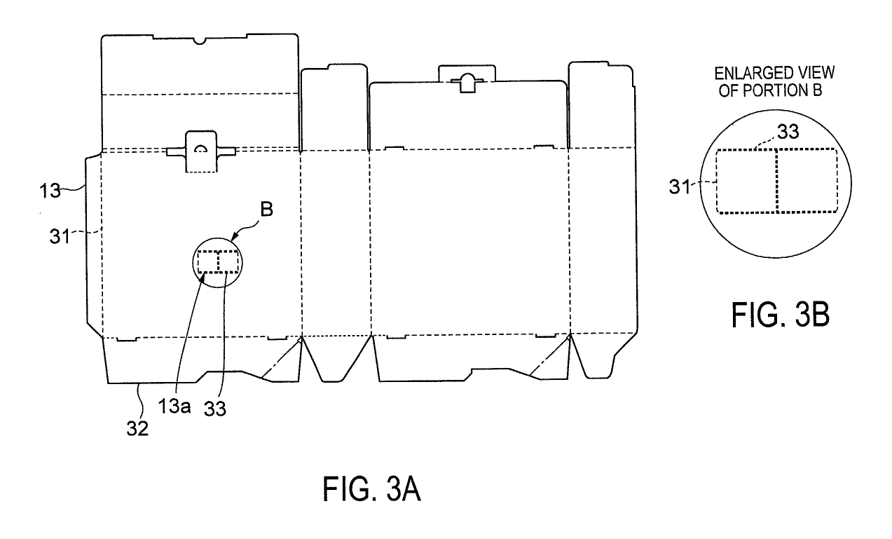

FIG. 3 shows the packing box 13 in its manufacturing process. FIG. 3A illustrates the packing box 13 in its developed state, and FIG. 3B is an enlarged view of portion B of FIG. 3A, namely, the window-forming portion 13a.

The packing box 13 is manufactured as one piece by blanking a material, e.g. paper material such as corrugated cardboard or cardboard. In the blanking process, a cutting portion 32 indicated by the solid line is formed simultaneously when a bending portion 31 indicated by a dashed line and a perforated portion 33 indicated by a dotted line are formed in at least one developed face. The material obtained by blanking is formed into the three-dimensional packing box 13 shown in FIG. 2A by bending all the developed faces in predetermined directions.

More specifically, the window-forming portion 13a is composed of the bending portions 31 indicated by the dashed lines and the perforated portions 33 indicated by the dotted lines, as shown in FIGS. 3A and 3B. The bending portions 31 bend and deform along the bending lines without partially breaking when subjected to a predetermined level of pressure by pushing them by a figure or the like. Hence, the bending portions 31 making up the window-forming portion 13a have a relatively lower bending strength than that of the remaining portion. In other words, the bending portions 31 can easily be bent.

The perforated portions 33 allow the window-forming portion 13a to be partially cut open along the perforated lines by applying a predetermined level of pressure by pushing the window-forming portion 13a by a figure or the like. Thus, the perforated lines may be replaced, for example, by partially cut lines or by portions partially decreased the strength to permit easy cutting (e.g., by decreasing the thickness thereof). In other words, the perforated portions 33 may have any structure as long as it allows the window-forming portion 13a to be partially cut along them by applying a predetermined level of pressure.

FIG. 4 includes the diagrams for explaining how the electronic device 11 is packed using the packing box 13 in accordance with the present embodiment. FIG. 4A shows the packing box 13 at the time of shipment from a manufacturer, FIG. 4B shows a protective member 12 to be placed in the packing box 13, and FIG. 4C shows the electronic device 11 to be protected and supported by the protective member 12.

As shown in FIG. 4A, the window-forming portion 13a in the packing box 13 at shipment remains unopened. Hence, the window-forming portion 13a is maintained in the unopened state during the transport and storage of the packing box 13.

The window-forming portion 13a is maintained in the unopened state unless a predetermined level of pressure is applied thereto; therefore, humidity, dust or the like does not enter into the packing box. This arrangement maintains good environmental resistance.

The strength at which the window-forming portion 13a yields and opens can be set to an appropriate level. To be more specific, the pressure resistance of the window-forming portion 13a can be decided by setting the ratio of the cut length to the connection (uncut) length making up the perforated portion 33 to an appropriate value. Specifically, if the cut length of the perforated portion 33 is larger than the connection length, then the window-forming portion 13a can be opened by applying relatively low pressure thereto. Conversely, if the cut length of the perforated portion 33 is smaller than the connection length, then a relatively high pressure has to be applied to open the window-forming portion 13a.

Thus, the need for reinforcing the protective member 12 as described in the prior art example can be obviated by setting the strength of the window-forming portion 13a to an appropriate value.

To pack the electronic device 11, a part (the lower part) of the protective member 12 is first placed in the packing box 13, then the electronic device 11 is placed in the packing box 13 and also installed into the part of the protective member 12 at the same time. Subsequently, the remaining part (the upper part) of the protective member 12 is placed in the packing box 13 and also placed over the electronic device 11 to cover it thereby to secure the electronic device 11 to the packing box 13 through the intermediary of the protective member 12. At this point, the electronic device 11 is in the packing box 13.

When the electronic device 11 has been accommodated and fixed in the packing box 13, the position of a bar code label 11a attached to the electronic device 11 or especially a bar code 11b on the bar code label 11a must coincide with the position of the window-forming portion 13a of the packing box 13. Hence, the position in which the bar code label 11a is attached is decided so that the position of the bar code 11b coincides with the position of the window-forming portion 13a of the packing box 13.

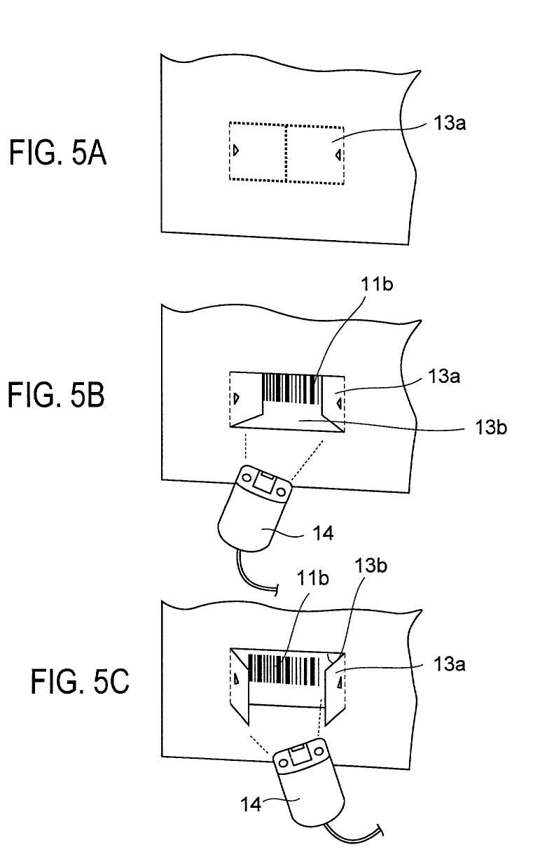

FIGS. 5A through 5C illustrate a state wherein the bar code 11b attached to the electronic device 11 is being read by a bar code reader. FIG. 5A shows the window-forming portion 13a of the packing box 13 in an unopened state before the bar code is read.

FIG. 5B shows a state wherein the window-forming portion 13a is pushed in by applying a predetermined level of pressure thereto with a figure or the like to open the window-forming portion 13a toward the inside of the packing box 13, and to form the window 13b. The bar code 11b attached to the electronic device 11 is exposed through the window 13b.

In the above state, the bar code 11b can be easily read by bringing a bar code reader 14 closely to the bar code 11b through the window 13b. FIG. 5C illustrates a similar step to that of FIG. 5B except that the opening direction of the window 13b is different. More specifically, a part of the window-forming portion 13a is drawn toward the front to open the window 13b toward the outside of the box, thereby exposing the bar code 11b. In this case, perforation may be formed such that a small hole can be formed at the center of the window-forming portion 13a. The central portion of the window-forming portion 13a is first pushed in with a figure to open the small hole, then the finger is inserted in the small hole to reach the rear side or the inner side of the window-forming portion 13a so as to pull out a part of the window-forming portion 13a.

The bar code reader 14 shown in FIGS. 5A through 5C is a hand-held type; however, the bar code reader is not limited thereto. For example, another type, such as a stationary type, may be used as the bar code reader 14. In this case, the packing box 13 is moved relatively to the bar code reader 14.

If the gap between the electronic device 11 and the packing box 13 is relatively large, then the push-in method illustrated in FIG. 5B is preferably used. Conversely, if the electronic device 11 and the packing box 13 are close to each other with little gap therebetween, then the pulling out method shown in FIG. 5C is preferably used. Whether the method wherein the window-forming portion 13a is pushed in or the method wherein it is pulled out should be selected is to be decided for individual cases, depending upon the relationship between the electronic device 11 and the packing box 13 and other conditions.

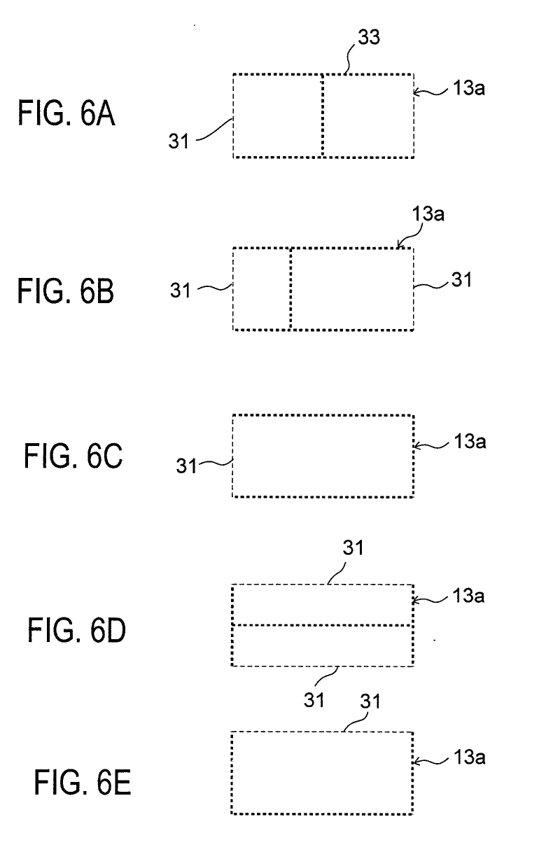

FIGS. 6A through 6E illustrate examples alternative to the bending portion 31 and the perforated portion 33 described in conjunction with FIG. 3B. FIG. 6A shows a structure that has right and left bending portions 31 and opens at the lateral center. FIG. 6B shows a structure that has right and left bending portions 31, and opens at a position biased to the left or right. FIG. 6C shows a structure that has the bending portion 31 at left or right, and fully opens at the right or left.

FIG. 6D shows a structure that has upper and lower bending portions 31, and opens at the vertical center. FIG. 6E shows a structure that has the bending portion 31 at top or bottom, and fully opens at the top or bottom.

Whether the method wherein the window-forming portion 13a is pushed in or the method wherein the window-forming portion 13a is pulled out to open the window-forming portion 13a can be selected on the basis of the gap between the packing box 13 and the electronic device 11, etc.

In the above embodiment, the descriptions have been given of reading the bar code 11b attached to the electronic device 11; however, the object to be read is not limited to the bar code 11b. The present invention can be also applied to reading of alphanumeric notation or other type of notation that provides commercial product identification information.

Furthermore, in this embodiment, the bar code reader 14 has been used as an example of a reading device; however, the reading device is not limited to the bar code reader 14. The reading device may alternatively be an optical character reader (OCR).

Furthermore, if a commercial product identification information is represented by an electromagnetic means, such as magnetic information, visible chromatic means, or mechanical means, such as concavity and convexity of a contour or roughness and smoothness of a surface, then a sensor or reader designed for these means are used. When appropriate, identification codes may be visually checked by naked eyes.

The embodiment provides the following advantages over the prior art example:

(1) The prior art example uses a large volume of the protective member 2.

In contrast to the prior art example, the embodiment requires an extremely small volume of the protective member 12. This makes it possible to significantly reduce the volume of the protective member 12 that is discarded when a user starts to use the electronic device 11. Thus, wasteful consumption of resources can be restrained.

(2) In the prior art example, the thickness of the portion around the window 2a of the protective member 2 is increased in order to reinforce the packing box 3. The presence of the protective member 2 inevitably leads to the relatively large gap between the packing box 3 and the bar code 1b, and the bar code 1b is positioned deeply in the packing box 3. Hence, the bar code reader has to be inserted in the window 2a of the protective member 2 in order to improve the accuracy of reading the bar code 1b. For this reason, the window 2a of the protective member 2 and the window 3a of the packing box 3 must be formed to the shape of a bar code reader. If the bar code 1b is read without inserting a bar code reader in the window 2a of the protective member 2, there is a possibility of deteriorated reading accuracy.

In the embodiment, since the window-forming portion 13a is formed so that it remains unopened unless a predetermined level of pressure is applied thereto, a sufficiently, high strength of the packing box 13 can be secured. This makes it possible to reduce the thickness of the protective member 12 accommodated in the packing box 13 together with the electronic device 11.

As a result, the distance between the packing box 13 and the bar code 11b will be relatively short, and the hand-held type bar code reader 14 is not necessarily required. Moreover, the reading accuracy of the bar code reader 14 can be improved.

(3) In the prior art example, during transport or storage, humidity, dust, etc. may enter the packing box through the window 2a of the protective member 2 that is opened from the beginning.

In the packing box 13 according to the embodiment, the packing box 13 can be virtually maintained in a sealed state from the point of shipment from a manufacturer to the moment the bar code 11b is read (e.g., until the point of sales). As a result, during the above-mentioned period, the influences of humidity, dust, etc. can be prevented. Thus, the packing box 13 featuring high environmental resistance can be achieved.

(4) In the prior art example, since the opening is formed in the packing box from the beginning, a third party could easily read, during transport or storage, the contents of the bar codes of many electronic devices being stored or transported.

In the packing box 13 according to the embodiment, the electronic device 11 shipped from a manufacturer can be kept confidential until, for example, it reaches an outlet store. At the outlet store, when the bar code 11b is individually read at the point of sales, and the data read from the bar code 11b is input to a computer or the like, it is possible to prevent the contents of the bar codes of many electronic devices from being easily read by a third party.

Furthermore, it can be easily determined whether the bar code 11b of the particular electronic device 11 has been read or not by checking the window-forming portion 13a for rupture. Therefore, if a third party should illegally read the bar code 11b, measures can be immediately taken against it. Moreover, when the bar code 11b is duly read at an outlet store, it is possible to prevent reading the same bar code 11b more than once to enter the data of the same electronic device 11b again.

The present invention makes it possible to provide a windowed packing box and a method for using the packing box that allow the cumbersome operation for taking out an electronic device and placing it back into a packing box to be obviated, and permit easy reading of an identification code attached to the electronic device.

Furthermore, the present invention makes it possible to provide a windowed packing box and a method for using the packing box that eliminate wasteful consumption of resources and permit easy reading of an identification code attached to an electronic device.

1. A packing box for accommodating an article therein, comprising:
a window-forming portion that is formed in at least one face of the box, and functions as a window when pressure is applied thereto.

2. A packing box according to claim 1, wherein
the window-forming portion remains unopened and functions as part of the face of the box until a predetermined level of pressure is applied thereto.

3. A packing box according to claim 1, wherein
the window-forming portion is formed in the face such that it is aligned with the position of an identification code on an article when the article is accommodated in the box.

4. A packing box according to claim 3, wherein
the article is accommodated in the box together with a protective member, and a gap exists between at least the window-forming portion and the article.

5. A packing box according to claim 3, wherein
the identification code is a bar code.

6. A packing box according to claim 1, wherein the window-forming portion includes a portion that can be partially cut with ease and a portion that can be partially bent with ease.

7. A packing box according to claim 6, wherein
the portion that can be partially cut with ease is composed of a combination of partial cut portion and connection portion.

8. A method for manufacturing a packing box for accommodating an article therein, comprising a step of:
forming a window-forming portion in at least one developed face of a plurality of developed faces making up the packing box, wherein the window-forming portion functions as a window when a predetermined level of pressure is applied thereto.

9. A method for manufacturing a packing box according to claim 8, wherein
the window-forming portion is formed in at least one of the developed faces at the same time when the plurality of developed faces are formed by blanking a paper material.

10. A method for manufacturing a packing box according to claim 8, wherein
the window-forming portion is formed by forming a portion that can be partially cut with ease and a portion that can be bent with ease in at least one developed face.

11. A method for using a packing box for accommodating an article therein, comprising the steps of:
forming a window-forming portion that functions as a window when subjected to a predetermined level of pressure in at least one face of the packing box;
attaching an identification code to the article;
placing the article in the packing box such that the position of the identification code attached to the article coincides with the position of the window-forming portion; and
applying the predetermined level of pressure to the window-forming portion to cause the window-forming portion to function as a window for reading the identification code on the article.

12. A method for using a packing box according to claim 11, wherein
the window-forming portion remains unopened until the predetermined level of pressure is applied thereto, and opens when subjected to the predetermined level of pressure so as to function as the window.

13. A method for using a packing box according to claim 11, wherein
the window-forming portion is formed by forming a portion that can be partially cut with ease and a portion that can be bent with ease in at least one face.

14. A method for using a packing box according to claim 11, wherein
the identification code attached to the article is a bar code.

15. A method for reading information from an identification code of an article accommodated in a packing box, wherein
the information of the identification code is read through a window-forming portion that is formed in at least one face of the packing box and functions as a window when subjected to a predetermined level of pressure.

16. A method for reading information according to claim 15, wherein
the window-forming portion is formed such that its position coincides with the position of the identification code attached to the article.

17. A method for reading information according to claim 15, wherein
the predetermined level of pressure is applied to the window-forming portion to cause the window-forming portion to function as the window when reading the identification code of the article.
